(19) United States
(12) Patent Application Publication
(10) Pub. No.: US 2025/0057083 A1
(43) Pub. Date: Feb. 20, 2025

(54) AXIAL FLOW REGULATION SYSTEM FOR GRAIN HARVESTING MACHINES

(71) Applicant: INDUSTRIAS COLOMBO S.A., Pindorama (BR)

(72) Inventors: Ighor Busnardo COLOMBO, PINDORAMA (BR); João Carlos VOLPI, PINDORAMA (BR); Beatriz Miano PAULINO, CATANDUVA (BR)

(21) Appl. No.: 18/796,532

(22) Filed: Aug. 7, 2024

(30) Foreign Application Priority Data
Aug. 17, 2023 (BR) 102023016621-0

(51) Int. Cl. A01F 12/28

(52) U.S. Cl. CPC A01F 12/28

(57) ABSTRACT

An axial flow regulation system for grain harvesting machines for regulation of the distance between the threshing cylinder or rotor and the concave portions, and the axial displacement of the material harvested during threshing.

### FIELD OF APPLICATION

The present description is in the field of grain harvesting machines.

### BACKGROUND OF THE INVENTION

A grain harvester, also known as a harvesting machine or mowing/threshing machine, is a specialized agricultural device for the harvesting process of various kinds of grains, such as wheat, maize, rice, soybeans and others.

The main constituents of a grain harvester include:
a cutting head: the front part of the harvester, which cuts the plants, separating grains from shafts, with different kinds of heads, each one appropriate for each specific crop;
a platform: a structure supporting the cutting head and connecting it to the harvester, being responsible for the stability and efficiency of the harvesting process;
a threshing rotor or cylinder: a rotating part separating grains from the harvested cobs, bolls or pods;
concave portions: surfaces with special shapes which, next to the rotor, help to separate the grains from undesired parts, such as straw and shells;
a cleaning system: constituted by screens and fans taking out impurities, dirt and other materials from the seeds as harvested;
a transport system: responsible for moving the harvested grains through different stages, up to the storage container, by means of conveyor belts, chains or screws;
a grain tank: a container where the harvested grains are temporarily stored until their transference to a supporting vessel or transshipment truck;
an unloading system: includes devices such as hatches and hinged arms, to unload the grains from the tank to the supporting vehicle or transshipment truck;
a propulsion engine and system: the grain harvesters are usually provided with internal combustion engines, such as diesel engines, providing the energy required to operate the machine;
an operator's cab: a compartment where the operator controls the harvester and monitors its performance, containing controls, dashboards and safety systems;
a control and monitoring system: the electronic and automation part of the harvester, allowing the operator to follow important data, such as yield, grain humidity and speed, among others; and
wheel sets and suspension: offering stability and mobility on different kinds of terrain.

The regulation between the threshing rotor or cylinder and the concave portions is a crucial step for the good performance of the grain harvester, since it is essential to guarantee that the grain is adequately separated from the undesired parts, such as straw, shells and other residues, resulting in efficient harvest with minimum loss of grain.

The distance between the threshing rotor or cylinder and the concave portions is called “slack” or “opening” and should be adjusted according to the type of crop to be harvested, the state of the crop (if dry or wet) and the grain variety, so to find the balance between efficient threshing and grain quality preservation.

Added to the correct slack regulation between the threshing rotor or cylinder and the concave portions, the retention or release of the axial flow of the harvested material along the threshing rotor or cylinder is an important aspect to improve the separation of the harvested grains in a grain harvester.

The retention or release of the axial flow of the harvested material refers to how grain and other plant parts are guided and kept in a specific route along the threshing rotor or cylinder while threshing.

By retaining or releasing the axial flow of the harvested material along the threshing rotor or cylinder, it is possible to obtain a series of benefits contributing for better grain separation:
appropriate time of residence: the axial flow control allows the harvested material to have longer contact with the threshing rotor or cylinder, providing for better efficiency in separating grains from the undesired portions, such as straw and husks, since the grains have more time to be released from cobs, bolls or pods;
higher exposition to separation elements: the axial control flow for the harvested material helps to keep the grains in contact with the concave portions, which surfaces with special shapes are designed to separate the grains from other parts of the plant, wherein the longer exposition improves the efficacy of that separation process;
grain loss reduction: the flow control for the harvested material reduces the loss of grain which could be dragged by air currents or fall before being duly separated, thus resulting in better efficiency and higher crop yield;
improved grain cleaning: by retaining or releasing the axial flow of the harvested material, the distribution of grain and straw within the harvester is more uniform, thus facilitating the cleaning process and impurity removal during separation; and
less part wearing: with the axial flow of the harvested material being adequately controlled, there is less impact and friction between harvester constituents, which may reduce their premature wearing and the need for frequent maintenance.

The development disclosed by the patent document U.S. Pat. No. 5,445,563 details an axial flow harvester with a concentric threshing and eccentric separation section containing a housing with an assembled rotating rotor, subdivided into threshing and separation portions, wherein the rotor frame is closed at its upper portion by lids with a different design, which may be exchanged by other lids with different measurements and, by the size of shape of the lids, put the rotor in an eccentric or concentric position over the rotor housing.

The development disclosed by the patent document U.S. Pat. No. 6,802,771 details an agricultural harvesting machine to remove and separate harvested crop grains, having a threshing zone and at least one separation zone to separate the grains, being the axial separation rotor surrounded, at least partially, by a separation housing with a series of sections, wherein at least one of the axially displaceable sections of the axial separation rotor is intended to increase the opening and guarantee the separation, when a correspondingly large proportion of grain is located outside the rotating harvesting flow and the mixture ratio is low.

The main inconvenience of the grain harvesters of the state of the art, concerning the distance regulation between the concave portions and the threshing rotor or cylinder, is their limitation, causing the set of concave portions to be jointly regulated, since the individual regulation of each concave portion results in the formation of steps inside the concave portions which are located against the flow of the harvested material.

The development disclosed by the patent document BR 0804364-7 details an adjustable shovel system for a combined rotating axial flow housing incorporating at least one flat wall section as a part of the curved, cylindrical or oblong housing cover, and adjustable shovels having flat bases adjusted in an angle over the surface of the flat wall section, said housing including fixed shovels over a curved portion of the housing cover having a front end, in a circumferential harvesting movement direction, substantially in register with rear edges of the adjustable shovels, including pivot connections near the rear edges and balancing connections near the front ends of the adjustable shovels, being all shovels adjustable, coupled and moved together, providing a device to hinge the adjustable shovels of a position corresponding to the normal helicoidal route of the fixed shovels to a deviation position, wherein the harvesting flow by the adjustable shovels will skip one or more passages between the fixed shovels in the next passage by the fixed shovels.

The main inconvenience of the grain harvesting machines of the state of the art, concerning the axial flow control for the harvested material, refers to their inability to change the displacement speed for that flow.

Therefore, the disclosure of means allowing to overcome the problems in the state of the art is desirable.

### SUMMARY OF THE INVENTION

The axial flow regulation system for grain harvesting machines of the invention presents the inclusion of a conical section in the initial part of the intermediate and final concave portions, aiming to allow the independent regulation of the concave portions, not forming steps located against the flow inside them and increasing regulation options, thus avoiding loss of quality of the beaten grains.

The axial flow regulation system for grain harvesters of the invention also presents, to control the flow of the harvested material, the inclusion of moving fins on the upper part of the concave portions, simulating helicoids, which steps may be regulated, thus influencing the displacement of the harvested material, aiming to contribute to guarantee the quality of the beaten grains.

The present invention seeks to provide an axial flow regulation system for grain harvesting machines and, more specifically, the regulation of the distance between the threshing cylinder or rotor and the concave portions, and the axial displacement of the material harvested during threshing.

The present also seeks to provide more regulation options for the concave portions over the threshing rotor or cylinder, and the displacement of the harvested material inside the concave portions, so to meet a wide range of use conditions; and to eliminate or significantly reduce grain loss.

### BRIEF DESCRIPTION OF DRAWINGS

FIG. 1 is a perspective view showing threshing rotors or cylinders located within a set formed by primary, intermediate and final concave portions.

FIG. 2 is an internal perspective view of the concave portions, showing the primary concave portion in its fully opened position.

FIG. 3 is an internal perspective view of the concave portions, showing the intermediate concave portion in its fully opened position.

FIG. 4 is an internal perspective view of the concave portions, showing the final concave portion in its fully opened position.

FIG. 5 is an internal perspective view of the concave portions, showing the primary, intermediate and final concave portions in their fully opened position.

FIG. 6 is an internal perspective view of the concave portions, showing the primary and final concave portions in their fully opened position.

FIG. 7 is an internal perspective view of the concave portions, showing the intermediate and final concave portions in their fully opened position.

FIG. 8 is an internal perspective view of the concave portions, showing the primary, intermediate and final concave portions in their fully opened position.

FIG. 9 is an internal perspective view of the concave portions, showing the primary, intermediate and final concave portions in their fully closed position.

FIG. 10 is a partial external perspective view of the primary concave portion, showing the regulation activator of the concave portion in its fully opened position.

FIG. 11 is a partial external perspective view of the intermediate concave portion, showing the regulation activator of the concave portion in its partially opened position.

FIG. 12 is a partial external perspective view of the final concave portion, showing the regulation activator of the concave portion in its fully closed position.

FIG. 13 is a partial external perspective view of the primary concave portion, showing the fin regulation activator in its fully opened position.

FIG. 14 is a partial external perspective view of the intermediate concave portion, showing the fin regulation activator in its partially opened position.

FIG. 15 is a partial external perspective view of the final concave portion, showing the fin regulation activator in its fully closed position.

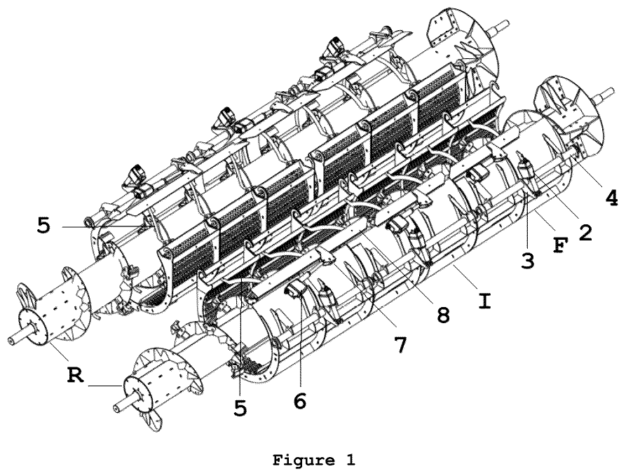

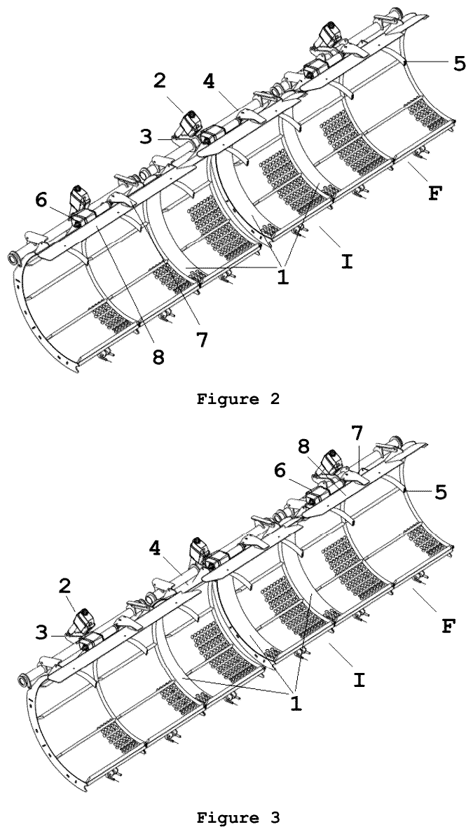

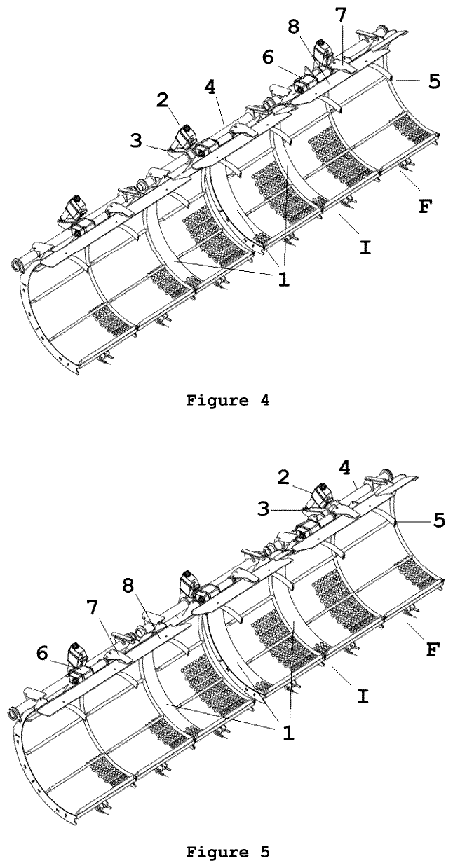

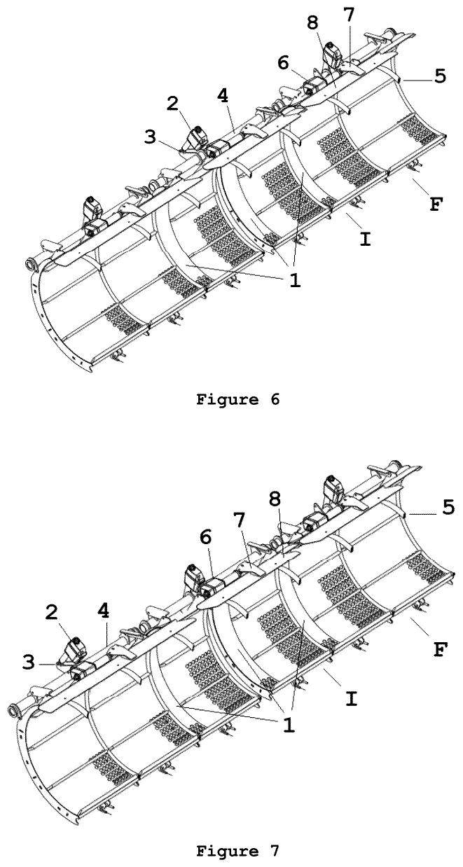

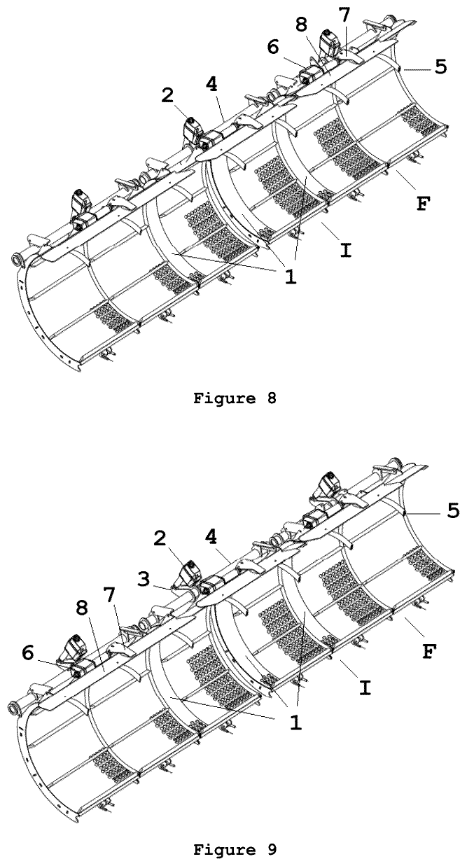

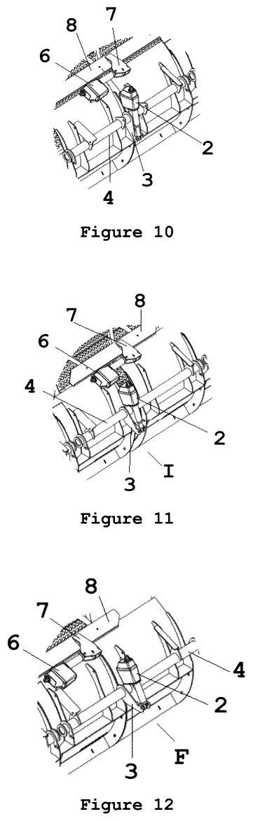

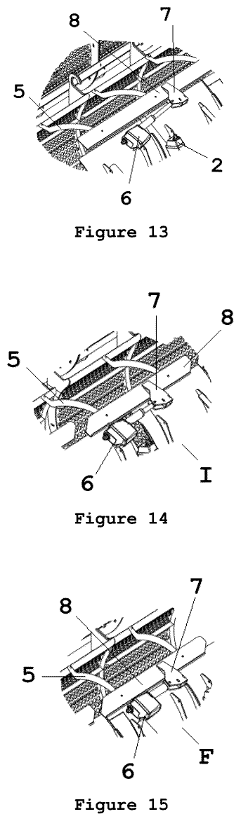

### DETAILED DESCRIPTION OF THE INVENTION

As shown by the attached figures, the axial flow regulation system for grain harvesting machines of the invention discloses the inclusion of a conical section (1) on the initial part of the intermediate (I) and final (F) concave portions, so to allow for the regulation in sectors of all concave portions over the threshing rotor or cylinder (R), thus eliminating the formation of steps inside the concave portions, as located in the harvested material flow direction, being the distance between each concave portion and the threshing rotor or cylinder regulated by electric, hydraulic or pneumatic actuators (2), which are fixed to the concave portions from the outside and hinged by fixed shafts (3) to the tube segments (4) located outside and lengthwise to the concave portions.

The axial flow regulation system for grain harvesting machines of the invention also discloses the inclusion of fins (5) on the upper side of the concave portions, influencing the flow of the harvested material, simulating helicoids, which angles may be regulated in sectors, so to increase or reduce its speed, by varying the beating time for the harvested material, by means of electric, hydraulic or pneumatic actuators (6), which are fixed over the concave portions and hinged to fixed shafts (4) in rule segments (8), located lengthwise over the concave portions, to which one of the edges of the fins is also hinged, wherein its opposed edges are also hinged to the opposed upper edge of the concave portions.

1. An axial flow regulation system for grain harvesting machines, comprising: a conical section on an initial portion of an intermediate and final concave portions, wherein a distance between each concave portion and a threshing rotor or cylinder is regulated by actuators, fixed outside the concave portions, and hinged to shafts attached to tube segments located on an outside, lengthwise to the concave portions.

2. The system of claim 1, wherein the conical section on the initial portion of the intermediate and final concave portions allowing for regulation of all concave portions in sections, over the threshing rotor or cylinder.

3. The system of claim 1, wherein the conical section on the initial portion of the intermediate and final concave portions avoiding a formation of steps inside the concave portions, in a flow direction of a harvested material.

4. An axial flow regulation system for grain harvesting machines, comprising: fins located over a concave portion, with an angle regulated by actuators, fixed to concave portions from an outside, hinged to shafts attached to rule segments located lengthwise over the concave portions, wherein one of fin edges is also hinged, and opposed edges are also hinged to an opposed upper edge of the concave portions.

5. The system of claim 4, wherein the fins influencing the displacement of a flow of a harvested material.

6. The system of claim 4, wherein the fins simulate helicoids.

7. The system of claim 4, wherein the fin angles are regulated in sectors, increasing or decreasing a path.

8. The system of claim 4, wherein the fin angles changing a beating time for a harvested material.

9. The system of claim 1 wherein the actuators are selected from the group consisting of: electric actuators, hydraulic actuators, and pneumatic actuators.

10. The system of claim 4 wherein the actuators are selected from the group consisting of: electric actuators, hydraulic actuators, and pneumatic actuators.
